(19) United States
(12) Patent Application Publication
(10) Pub. No.: US 2002/0061819 A1
(43) Pub. Date: May 23, 2002

(54) Heat-sensitive recording material

(76) Inventor: Osamu Ohno, Nichinan-shi (JP)

Correspondence Address: KUBOVCIK & KUBOVCIK, SUITE 710, 900 17TH STREET NW, WASHINGTON, DC, 20006

(21) Appl. No.: 09/928,916

(22) Filed: Aug. 14, 2001

Related U.S. Application Data
(63) Continuation of application No. PCT/JP01/06622, filed on Aug. 1, 2001.

(30) Foreign Application Priority Data
Aug. 11, 2000 (JP) 2000-243631

(51) Int. Cl. B41M 5/30

(52) U.S. Cl. 503/216

(57) ABSTRACT

Disclosed is a heat-sensitive recording material comprising a support and a heat-sensitive recording layer which is formed on the support and contains a leuco dye, a developer, a sensitizer and a binder, the heat-sensitive recording material using, as the developer, at least one member selected from the group consisting of N-(p-toluenesulfonyl)-m-aminophenol and N-(p-toluenesulfonyl)-p-aminophenol, and as the sensitizer, (a) at least one member selected from the group consisting of 1,2-diphenoxyethane, 1,2-di(3-methylphenoxy)ethane, 2-naphthyl benzyl ether and di-p-methylbenzyl oxalate and (b) a higher fatty acid amide such as stearic acid amide.

### TECHNICAL FIELD

The present invention relates to a heat-sensitive recording material which makes use of a color-forming reaction between a leuco dye and a developer.

### BACKGROUND ART

Heat-sensitive recording materials which make use of the color forming reaction of a leuco dye with a developer induced by heat are relatively inexpensive, and recording devices for these materials are compact and easy to maintain. Consequently such recording materials are widely used as recording media for facsimile systems, computers and other application.

With the expansion of the scope of application of such heat-sensitive recording materials, there is a demand for a heat-sensitive recording material which can provide a recorded portion (i.e., recorded image) formed by the color forming reaction between a leuco dye and a developer and having high resistance to plasticizers, edible oils, cosmetics or other compounds.

Japanese Unexamined Patent Publication No. 1987-170388 discloses a heat-sensitive recording material using N-(p-toluenesulfonyl)-p-aminophenol or N-(p-toluenesulfonyl)-m-aminophenol as a developer and using stearic acid amide as a sensitizer to increase the recorded image stability and recording sensitivity. However, this heat-sensitive recording material has problems in recording sensitivity and runnability during recording. More specifically, the heat-sensitive recording material disclosed in this publication, when used in heat-sensitive recording, tends to stick to a thermal head (hereinafter referred to as “sticking”), so that the image quality of the recorded portion (i.e., recorded image) tends to be disadvantageously reduced.

Japanese Unexamined Publication No. 1992-278385 discloses that the heat-sensitive recording material using a graft copolymer of starch and polyvinyl acetate as a binder has high runnability during recording. This recording material, however, is problematic in that the color density of its recorded portion (i.e., recorded image) is likely to decrease with time when exposed to heat or humidity.

### DISCLOSURE OF THE INVENTION

An object of the present invention is to provide a heat-sensitive recording material which can give a recorded portion excellent in stability against heat and humidity and which is excellent in resistance to background fogging and runnability during recording.

The inventors of the present invention conducted extensive research to achieve the above object. Consequently, in a heat-sensitive recording material comprising a support and a heat-sensitive recording layer which is formed on the support and which contains a leuco dye, a developer, a sensitizer and a binder, the present invention uses, as a means to achieve the above object, at least one member selected from the group consisting of N-(p-toluenesulfonyl)-m-aminophenol and N-(p-toluenesulfonyl)-p-aminophenol as the developer, and (a) at least one member selected from the group consisting of 1,2-diphenoxyethane, 1,2-di(3-methylphenoxy)ethane, 2-naphthyl benzyl ether and di-p-methylbenzyl oxalate and (b) a higher fatty acid amide as the sensitizer.

Thus, the present invention provides the following heat-sensitive recording materials.

1. A heat-sensitive recording material comprising a support and a heat-sensitive recording layer formed on the support, the heat-sensitive recording layer containing a leuco dye, a developer, a sensitizer and a binder, the developer being at least one member selected from the group consisting of N-(p-toluenesulfonyl)-m-aminophenol represented by formula (1)

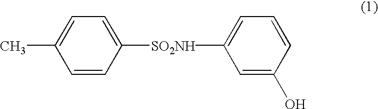

and N-(p-toluenesulfonyl)-p-aminophenol represented by formula (2)

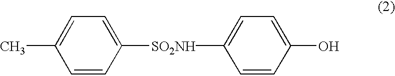

and, the sensitizer being (a) at least one member selected from the group consisting of 1,2-diphenoxyethane, 1,2-di(3-methylphenoxy)ethane, 2-naphthylbenzylether and di-p-methylbenzyl oxalate and (b) a higher fatty acid amide.

2. The heat-sensitive recording material according to item 1, wherein the developer is N-(p-toluenesulfonyl)-p-aminophenol represented by formula (2).

3. The heat-sensitive recording material according to item 1 or 2, wherein the amount of (a) said at least one member selected from the group consisting of 1,2-diphenoxyethane, 1,2-di(3-methylphenoxy)ethane, 2-naphthyl benzyl ether and di-p-methylbenzyl oxalate is 40 to 400% by weight, based on (b) said higher fatty acid amide.

4. The heat-sensitive recording material according to item 1 or 2, wherein the amount of (a) said at least one member selected from the group consisting of 1,2-diphenoxyethane, 1,2-di(3-methylphenoxy)ethane, 2-naphthyl benzyl ether and di-p-methylbenzyl oxalate is about 50 to 200% by weight, based on (b) said higher fatty acid amide.

5. The heat-sensitive recording material according to any one of items 1 to 4, wherein the sensitizers are 2-naphthyl benzyl ether and higher fatty acid amide.

6. The heat-sensitive recording material according to any one of items 1 to 5, wherein the higher fatty acid amide is stearic acid amide.

7. The heat-sensitive recording material according to any one of items 1 to 6, wherein the heat-sensitive recording layer further contains a print stability-improving agent.

8. The heat-sensitive recording material according to item 7, wherein the print stability-improving agent is a phenol resin.

9. The heat-sensitive recording material according to any one of items 1 to 8, wherein the leuco dye is at least one member selected from the group consisting of 3-di(n-butyl)amino-6-methyl-7-anilinofluoran, 3-di(n-pentyl)amino-6-methyl-7-anilinofluoran and 3-(N-ethyl-N-isoamylamino)-6-methyl-7-anilinofluoran.

10. The heat-sensitive recording material according to any one of items 1 to 9, wherein the binder in the heat-sensitive recording layer is a graft copolymer of starch and polyvinyl acetate.

11. The heat-sensitive recording material according to item 10, wherein the graft copolymer has a degree of graft copolymerization of polyvinyl acetate to starch of 0.5 to 10% by weight.

12. The heat-sensitive recording material according to any one of items 1 to 11 which further comprises a protective layer on the heat-sensitive recording layer, the protective layer containing a binder having a film forming ability and, if desired, a pigment.

13. The heat-sensitive recording material according to any one of items 1 to 12 which further comprises an undercoat layer between the support and the heat-sensitive recording layer, the undercoat layer containing (i) a binder and (ii) at least one member selected from the group consisting of oil absorbing pigments having an oil absorption of at least 70 ml/100 g and organic hollow particles.

14. The heat-sensitive recording material according to item 13, wherein the oil absorbing pigment is at least one inorganic pigment selected from the group consisting of calcined clay, amorphous silica, precipitated calcium carbonate and talc, primary particles of said at least one inorganic pigment having an average particle diameter of about 0.01 to 5 μm.

15. The heat-sensitive recording material according to item 13, wherein the organic hollow particles comprise a shell made of an acrylic resin, a styrene-based resin or a vinylidene chloride-based resin, the hollow particles having a hollowness of about 50 to 99% and an average particle diameter of about 0.5 to 10 μm.

### DETAILED DESCRIPTION OF THE INVENTION

The present invention is a heat-sensitive recording material comprising a support and a heat-sensitive recording layer formed on the support, and is characterized in that the heat-sensitive recording layer contains a specific developer which is at least one member selected from the group consisting of N-(p-toluenesulfonyl)-m-aminophenol represented by the formula (1) above and N-(p-toluenesulfonyl)-p-aminophenol represented by the formula (2) above, and specific sensitizers which are at least one member selected from the group consisting of 1,2-diphenoxyethane, 1,2-di(3-methylphenoxy)ethane, 2-naphthyl benzyl ether and di-p-methylbenzyl oxalate, and a higher fatty acid amide.

The addition of the specific developer and the specific sensitizers to the heat-sensitive recording layer increases the recording density and long-term stability of the recorded portion.

Support

Various supports are used in the present invention. Typical examples include wood free paper (acid-free paper or acid paper), synthetic paper, transparent films and other supports.

Thickness of these supports is not particularly limited. Preferable thickness is generally about 30 to 300 μm.

Specific Developer

The above specific developers for use in the present invention, namely N-(p-toluenesulfonyl)-m-aminophenol and N-(p-toluenesulfonyl)-p-aminophenol, are the compounds represented by the following formula (1) and formula (2), respectively.

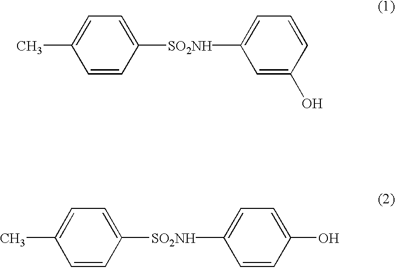

These compounds are both known and readily available.

The amount of the above specific developer to be used is not particularly limited. The amount is preferably about 1 to 50% by weight, more preferably about 5 to 30% by weight, based on the heat-sensitive recording layer.

Among the specific developers, N-(p-toluenesulfonyl)-p-aminophenol represented by the formula (2) above is preferable because it imparts high resistance to background fogging.

Specific Sensitizers

In the specific sensitizers used in the present invention, the ratio of (a) said at least one member selected from the group consisting of 1,2-diphenoxyethane, 1,2-di(3-methylphenoxy)ethane, 2-naphthyl benzyl ether and di-p-methylbenzyl oxalate to (b) said higher fatty acid amide, is not particularly limited. Preferably, the amount of (a) said at least one member selected from the group consisting of 1,2-diphenoxyethane, 1,2-di(3-methylphenoxy)ethane, 2-naphthyl benzyl ether and di-p-methylbenzyl oxalate is about 40 to 400% by weight, particularly about 50 to 200% by weight, more preferably about 70 to 160% by weight, based on (b) said higher fatty acid amide.

Examples of the higher fatty acid amide include stearic acid amide, behenic acid amide, oleic acid amide, methylenebisstearamide, ethylenebisstearamide and the like. Among these, stearic acid amide is preferable. Particularly preferable is stearic acid amide which has been emulsified and dispersed until an average particle diameter of 0.8 μm or less is attained.

The amount of the above specific sensitizers to be used is not particularly limited. The amount is preferably about 1 to 50% by weight, more preferably about 5 to 30% by weight, based on the heat-sensitive recording layer.

The ratio of the specific sensitizers to the above specific developer is not particularly limited. The specific sensitizers are used preferably in an amount of about 5 to 200% by weight, more preferably about 50 to 150% by weight, based on the specific developer.

Leuco Dye

The leuco dye contained in the heat-sensitive recording layer may be any of those heretofore known. Examples of such leuco dye include 3,3-bis(p-dimethylaminophenyl)-6-dimethylaminophthalide, 3-(4-diethylamino-2-methylphenyl)-3-(4-dimethylaminophenyl)-6-dimethylaminophthalide, 3-diethylamino-7-dibenzylamino-benzo[a]fluoran and like dyes which form blue color, 3-(N-ethyl-N-p-tolyl)amino-7-N-methylanilinofluoran, 3-diethylamino-7-anilinofluoran, 3-diethylamino-7-dibenzylaminofluoran and like dyes which form green color, 3-cyclohexylamino-6-chlorofluoran, 3-diethylamino-6-methyl-7-chlorofluoran, 3-diethylamino-7-chlorofluoran, rhodamine(o-chloroanilino)lactam, 3-diethylamino-6,8-dimethylfluoran and like dyes which form red color, 3-(N-ethyl-N-isoamyl)amino-6-methyl-7-anilinofluoran, 3-(N-methyl-N-cyclohexyl)amino-6-methyl-7-anilinofluoran, 3-diethylamino-6-methyl-7-anilinofluoran, 3-di(n-butyl)amino-6-methyl-7-anilinofluoran, 3-di(n-butyl)amino-7-(o-fluorophenylamino)fluoran, 3-(N-ethyl-p-toluidino)-6-methyl-7-anilinofluoran, 3-(N-ethyl-N-tetrahydrofurfuryl-amino)-6-methyl-7-anilinofluoran, 3-diethylamino-6-chloro-7-anilinofluoran, 3-pyrrolidino-6-methyl-7-anilinofluoran, 3-piperidino-6-methyl-7-anilinofluoran and like dyes which form black color, 3,3-bis[1-(4-methoxyphenyl)-1-(4-dimethylaminophenyl)ethylen-2-yl]-4,5,6,7-tetrachlorophthalide, 3-p-(p-dimethylaminoanilino) anilino-6-methyl-7-chlorofluoran, 3-p-(p-chloroanilino)anilino-6-methyl-7-chlorofluoran, 3,6-bis(dimethylamino)fluorene-9-spiro-3′-(6′-dimethylamino)phthalide and like dyes with absorption wavelengths in the near infrared region, among others.

The above specific developer used in the present invention is favorable because it develops a black color having no hue when used with 3-di(n-butyl)amino-6-methyl-7-anilinofluoran, 3-di(n-pentyl)amino-6-methyl-7-anilinofluoran and 3-(N-ethyl-N-isoamyl)amino-6-methyl-7-anilinofluoran, which are dyes capable of forming black color.

Of course, the leuco dyes are not limited to these leuco dyes, and two or more leuco dyes may be used in admixture. Preferably, the weight ratio of the leuco dye (A) to the specific developer (B) to be used is, but is not limited to, (A):(B)=about 1:8 to 2:1, particularly about 1:5 to 1:1.

Other Developers

The present invention uses the specific developer as a developer, but other known developers may be additionally used unless they impair the contemplated effects of the present invention.

Examples of other developers include 4,4′-dihydroxydiphenylsulfone, 2,2′-bis[4-(4-hydroxyphenyl-sulfonyl)phenoxy]diethyl ether, 4-hydroxy-4′-isopropoxydiphenylsulfone, 2,4′-dihydroxydiphenylsulfone, bis(3-allyl-4-hydroxyphenyl)sulfone, 2,4-bis(phenylsulfonyl)phenol, 4,4,-isopropylidenediphenol, 4,4,-cyclohexylidenediphenol, 2,2-bis(4-hydroxyphenyl)-4-methylpentane, benzyl 4-hydroxybenzoate, 1,1-bis(4-hydroxyphenyl)-1-phenylethane and like phenolic compounds, N-(p-tolylsulfonyl)carbamic acid p-cumylphenyl ester, N-(o-tolyl)-p-tolylsulfonamide, 4,4′-bis (N-p-tolylsulfonylaminocarbonylamino)diphenylmethane and like compounds having a —SO₂NH— bond within the molecule, zinc 4-[2-(p-methoxyphenoxy)ethyloxy]salicylate, zinc 4-[3-(p-tolylsulfonyl)propyloxy]salicylate, 5-[p-(2-p-methoxyphenoxyethoxy)cumyl]salicylic acid and like zinc salts of aromatic carboxylic acids.

These other developers, if employed, are preferably used in an amount of about 5 to 80 parts by weight, particularly about 10 to 50 parts by weight, per 100 parts by weight of the above specific developer.

Other Sensitizers

The heat-sensitive recording layer may also contain other various known sensitizers to enhance its recording sensitivity, in addition to the specific sensitizers.

Examples of said other sensitizers include dibenzyl terephthalate, benzyl p-benzyloxybenzoate, m-terphenyl, p-benzylbiphenyl, p-tolyl biphenyl ether, di(4-methoxyphenoxyethyl)ether, 1,2-di(4-methylphenoxy)ethane, 1,2-di(4-methoxyphenoxy)ethane, 1,2-di(4-chlorophenoxy)ethane, 1-(4-methoxyphenoxy)-2-(3-methylphenoxy)ethane, p-methylthiophenylbenzyl ether, di(β-biphenylethoxy)benzene, di-p-chlorobenzyl oxalate, dibenzyl oxalate, among others.

These other sensitizers, if employed, are preferably used in an amount of about 10 to 100 parts by weight, particularly about 20 to 50 parts by weight, per 100 parts by weight of the sum of the weights of the above specific sensitizers (a) and (b).

Print Stability-Improving Agent

In the present invention, the heat-sensitive recording layer may contain various known print stability-improving agents to enhance the long-term stability of the recorded portion.

Examples of such print stability-improving agents include phenol resins such as novolac phenol resins and resol phenol resins, 2,2′-methylenebis(4-methyl-6-tert-butylphenol), 4,4′-thiobis(2-methyl-6-tert-butylphenol), 4,4,-butylidenebis(6-tert-butyl-m-cresol), 1,1,3-tris(2-methyl-4-hydroxy-5-tert-butylphenyl)butane, 1,1,3-tris(2-methyl-4-hydroxy-5-cyclohexylphenyl)butane, 2,2-bis(4-hydroxy-3,5-dibromophenyl)propane, 2,2-bis(4-hydroxy-3,5-dimethylphenyl)propane and like hindered phenol compounds, 4,4,-diglycidyloxydiphenylsulfone, 4-benzyloxy-4′-(2-methylglycidyloxy)diphenylsulfone, diglycidyl terephthalate, phenol novolac epoxy resin, cresol novolac epoxy resin, bisphenol A epoxy resin and like epoxy compounds, among others. The phenol resins are preferable among them.

When these print stability-improving agents are used, their amounts are not particularly limited. In general, the amount is preferably about 0.1 to 5 parts by weight, particularly about 0.2 to 3 parts by weight, per part by weight of the leuco dye.

Binder

Examples of the binder include a starch-polyvinyl acetate graft copolymer, polyvinyl alcohol, carboxy-modified polyvinyl alcohol, acetoacetyl-modified polyvinyl alcohol, silicon-modified polyvinyl alcohol, oxidized starch, casein, styrene-maleic anhydride copolymer, methyl vinyl ether-maleic anhydride copolymer, isopropylene-maleic anhydride copolymer and like water-soluble resins, and styrene-butadiene-based latex, acrylic latex, urethane-based latex and like water-dispersible resins.

The amount of the binder to be used is not limited, but it is preferably about 5 to 35% by weight, more preferably about 8 to 30% by weight, based on the heat-sensitive recording layer.

Among the above binders, the specific binder which is the graft copolymer of starch and polyvinyl acetate is particularly preferable because it imparts excellent runnability during recording and resistance to background fogging. The specific binder can be prepared, for example, by directly grafting polyvinyl acetate to starch comprising amylose and amylopectin and obtained from corn, potato, sweet potato and the like or to a modified starch such as oxidized starch, esterified starch or the like, or by graft polymerization of vinyl acetate monomer to starch. The degree of graft copolymerization of polyvinyl acetate is about 0.5 to 10% by weight, particularly about 1 to 5% by weight, based on starch. Part of the polyvinyl acetate in the specific binder may be saponified. Such a starch-polyvinyl acetate graft copolymer is known and commercially available.

Heat-Sensitive Recording Layer

The heat-sensitive recording layer is formed as follows. The above-mentioned leuco dye, specific developer and specific sensitizers and, if necessary, a print stability-improving agent are pulverized usually in water serving as a dispersion medium, either jointly or separately, by means of a ball mill, an attritor, a sand mill or like mixing and pulverizing apparatus to an average particle diameter of about 2 μm or less. A binder is added to the resulting dispersion, giving a coating composition for forming a heat-sensitive recording layer. The coating composition is applied to a support such as wood free paper (acid-free paper or acid paper), synthetic paper, transparent film or the like, and the coating is dried.

Further, the coating composition for forming a heat-sensitive recording layer may contain various auxiliaries, if necessary. Examples thereof include kaolin, precipitated calcium carbonate, ground calcium carbonate, calcined kaolin, titanium oxide, magnesium carbonate, aluminium hydroxide, amorphous silica, urea-formalin resin filler and like pigments, sodium dioctylsulfosuccinate, sodium dodecylbenzenesulphonate, sodium lauryl sulfate, fatty acid metal salts and like surfactants, zinc stearate, calcium stearate, polyethylene wax, carnauba wax, paraffin wax, ester wax and like waxes, glyoxal, urea formalin resin, polyamide epoxy resin, polyamide-epichlorohydrin, adipic dihydrazide, boric acid, borax, ammonium zirconium carbonate and like insolubilizers, ultraviolet absorbers, antifoaming agents, fluorescent dyes, coloring dyes, among others.

The coating composition for forming a heat-sensitive recording layer is applied in an amount of 2 to 12 g/m², preferably about 3 to 7 g/m², on a dry weight basis. The coating composition for forming a heat-sensitive recording layer may be applied by any of heretofore known methods.

Protective Layer

A protective layer may be provided on the heat-sensitive recording layer to increase chemical resistance, water resistance and runnability during recording. Such protective layer is formed, for example, by applying to the heat-sensitive recording layer a coating composition for forming a protective layer comprising as main component a binder having a film-forming ability and, if desired, a pigment.

Examples of a binder contained in the coating composition for forming a protective layer include completely saponified polyvinyl alcohol, partially saponified polyvinyl alcohol, carboxy-modified polyvinyl alcohol, acetoacetyl-modified polyvinyl alcohol, silicon-modified polyvinyl alcohol, diacetone-modified polyvinyl alcohol and like polyvinyl alcohols, starches, hydroxy-ethylcellulose, methylcellulose, carboxymethyl cellulose, gelatin, casein, gum arabic, isobutylene-maleic anhydride copolymer salts, styrene-maleic anhydride copolymer salts, ethylene-acrylic acid copolymer salts, styrene-acrylic acid copolymer salts, styrene-butadiene-based latex, acrylic latex, urethane-based latex, among others.

The amount of the binder to be used may be selected from a wide range. It is generally preferable to use the binder in an amount of about 10 to 100% by weight, particularly about 30 to 90% by weight, based on the protective layer.

Examples of the pigment which is optionally contained in the protective layer may be those which are optionally contained in the above heat-sensitive recording layer. The pigment, if employed, is preferably used in an amount of about 5 to 80% by weight, particularly about 20 to 70% by weight, based on the protective layer.

Further, the coating composition for forming a protective layer may contain the auxiliaries which may be contained in the above coating composition for forming a heat-sensitive recording layer.

The coating composition for forming a protective layer is applied in an amount of 0.5 to 10 g/m², preferably about 1 to 5 g/m², on a dry weight basis. Methods for applying a coating composition to form a protective layer include any heretofore known methods.

Undercoat Layer

In the present invention, an undercoat layer may be provided, if necessary, between the support and the heat-sensitive recording layer, to increase the recording sensitivity and runnability during recording. The undercoat layer is formed by applying a coating composition for forming an undercoat layer to the support, and drying the coating composition, wherein the coating composition for forming an undercoat layer comprises, as main components, a binder, and an oil absorbing pigment having an oil absorption of 70 ml/100 g or higher, particularly about 80 to 150 ml/100 g, and/or hollow organic particles. Herein, the oil absorption is a value determined by the method of JIS K5101.

Useful oil absorbing pigments include various pigments. Typical examples include calcined clay, amorphous silica, precipitated calcium carbonate, talc and like inorganic pigments. Primary particles of these oil absorbing pigments preferably have an average particle diameter of about 0.01 to 5 μm, particularly about 0.02 to 3 μm. The amount of the oil absorbing pigment used may be selected from a wide range. A preferable amount is generally 50 to 95% by weight, particularly about 70 to 90% by weight, based on the undercoat layer.

Useful hollow organic particles include those heretofore known, such as particles comprising a shell made of acrylic resin, styrenic resin, vinylidene chloride-based resin, etc., and having a hollowness of about 50 to 99%. Herein, hollowness denotes the value calculated by the equation (d/D)×100. In this equation, d represents the inside diameter of hollow organic particles, and D represents the outside diameter of hollow organic particles. An average particle diameter of the hollow organic particles is preferably about 0.5 to 10 μm, particularly about 1 to 3 μm. The amount of the hollow organic particles used may be selected from a wide range, but is generally 20 to 90% by weight, particularly about 30 to 70% by weight, based on the undercoat layer.

When using the above inorganic oil absorbing pigment in combination with the hollow organic particles, it is preferable that the inorganic oil absorbing pigment and hollow organic particles are used in an amount within the above-specified range and that the total amount of the inorganic oil absorbing pigment and hollow organic particles is preferably about 40 to 90% by weight, particularly about 50 to 80% by weight, based on the undercoat layer.

Preferable binders include those binders which may be used in the heat-sensitive recording layer, particularly starch-vinyl acetate graft copolymer, polyvinyl alcohol, styrene-butadiene-based latex, etc.

The amount of the binder used may be selected from a wide range. However, it is generally preferable to use the binder in an amount of about 5 to 30% by weight, particularly about 10 to 20% by weight, based on the undercoat layer.

The coating composition for forming the undercoat layer is preferably applied in an amount of about 3 to 20 g/m², preferably about 5 to 12 g/m², on a dry weight basis. A coating composition for forming undercoat layer may be applied by any of heretofore known methods.

Further, in the present invention, it is preferable that the pH of cold aqueous extracts (according to JIS P 8133) of the heat-sensitive recording material of the invention is about 6.0 to 9.0. The pH lower than 6.0 causes background fogging in the heat-sensitive recording layer, whereas the pH higher than 9.0 may lower the density of a recorded portion with time. More preferably, the pH is about 7.0 to 8.5.

The pH of the cold aqueous extracts of the heat-sensitive recording material can be adjusted to about 6.0 to 9.0 by various methods. For example, a support which is made of an acid-free paper produced by paper machine is used; or a basic pigment such as calcium carbonate, magnesium carbonate or the like is added to the heat-sensitive recording layer; or the pH of the coating composition for forming a heat-sensitive recording layer is adjusted to about 6.0 to 9.0 by a water-soluble acid compound or an alkaline compound; etc.

The heat-sensitive recording material of the present invention may be subjected to a smoothing treatment by a supercalender after forming each layer. The heat-sensitive recording material of the present invention may be modified, if necessary, by utilizing a variety of other known techniques used in the production of heat-sensitive recording materials.

### EXAMPLES

The present invention will be explained in further detail with reference to Examples below. Of course, the present invention is not limited to these Examples. In the examples, “parts” and “%” are “parts by weight” and “% by weight”, respectively, unless otherwise specified.

### Example 1

Preparation of Coating Composition for Forming Undercoat Layer

A composition was prepared by mixing 70 parts of calcined clay (trade name: Ansilex, manufactured by Engelhard Corporation, oil absorption: 110 ml/100 g), 38 parts of a plastic pigment (trade name: Glossdell 104S, solid content: 46%, manufactured by MITSUI CHEMICALS, INC.), 33 parts of a 12% aqueous solution of a starch-polyvinyl acetate graft copolymer (trade name: Petrocoat C-8, manufactured by NIPPON STARCH CHEMICAL CO.,LTD.), 2 parts of carboxymethyl cellulose (trade name: Cellogen 7A, manufactured by DAI-ICHI KOGYO SEIYAKU CO,. LTD.), 14 parts of styrene-butadiene latex (trade name: L-1537Y, solid content: 50%, manufactured by ASAHI CHEMICAL INDUSTRY CO., LTD.) and 100 parts of water. The composition was mixed and stirred with a high-speed agitator, giving a coating composition for forming an undercoat layer.

Preparation of Dispersion A

A composition composed of 40 parts of 3-di(n-butyl)amino-6-methyl-7-anilinofluoran, 10 parts of a 10% aqueous solution of carboxy-modified polyvinyl alcohol (degree of polymerization: 500) and 50 parts of water was pulverized with a sand grinder until an average particle diameter of 0.8 μm was attained.

Preparation of Dispersion B

A composition composed of 40 parts of N-(p-toluenesulfonyl)-p-aminophenol represented by formula (2) above, 10 parts of a 10% aqueous solution of carboxy-modified polyvinyl alcohol (degree of polymerization: 500) and 50 parts of water was pulverized with a sand grinder until an average particle diameter of 1.0 μm or smaller was attained.

Preparation of Dispersion C

A composition composed of 40 parts of 1,2-diphenoxyethane, 10 parts of a 10% aqueous solution of carboxy-modified polyvinyl alcohol (degree of polymerization: 500) and 50 parts of water was pulverized with a sand grinder until an average particle diameter of 1.0 μor smaller was attained.

Preparation of Dispersion D

A composition composed of 40 parts of a phenol resin (trade name: Shonol CKP2400P, manufactured by SHOWA HIGHPOLYMER CO.,LTD.), 10 parts of a 10% aqueous solution of carboxy-modified polyvinyl alcohol (degree of polymerization: 500) and 50 parts of water was pulverized with a sand grinder until an average particle diameter of 1.0 μor smaller was attained.

Preparation of Coating Composition for Forming Recording Layer

A composition composed of 20 parts of Dispersion A, 55 parts of Dispersion B, 30 parts of Dispersion C, 4 parts of Dispersion D, 40 parts of a 20% dispersion of stearic acid amide (trade name: HYMICRON G-270, emulsified and dispersed product, average particle diameter: 0.5 μm, manufactured by Chukyo Oil and Fat Co., Ltd.), 10 parts of calcium carbonate (trade name: Brilliant 15, manufactured by SHIRAISHI CALCIUM KAISHA), 10 parts of alminium hydroxide (trade name: HIGILITE H-42, manufactured by Showa Denko Kabushiki Kaisha), 20 parts of a 30% dispersion of zinc stearate, 30 parts of a 30% dispersion of paraffin wax, 50 parts of a 20% aqueous solution of vinyl acetate-grafted starch (trade name: Petrocoat C-8, manufactured by NIPPON STARCH CHEMICAL CO.,LTD.), 20 parts of a 10% aqueous solution of polyvinyl alcohol (trade name: PVA-110, manufactured by KURARAY CO.,LTD.) and 30 parts of water was stirred and mixed, giving a coating composition for forming a heat-sensitive recording layer.

Preparation of Heat-Sensitive Recording Material

To one side of a neutral wood free paper weighing 64 g/m² were successively applied the coating composition for forming undercoat layer and the coating composition for forming heat-sensitive recording layer in an amount of 8 g/m² and 5 g/m², respectively, on dry weight basis with a rod blade coater, and dried, thereby successively forming an undercoat layer and a heat-sensitive recording. This paper was subjected to smoothing treatment with a supercalender so that Oken type smoothness (JAPAN TAPPI No. 5) of 1500 seconds was attained, giving a heat-sensitive recording material.

### Example 2

A heat-sensitive recording material was prepared in the same manner as in Example 1 with the exception of using 1,2-di(3-methylphenoxy)ethane in place of 1,2-diphenoxyethane in the preparation of Dispersion C in Example 1.

### Example 3

A heat-sensitive recording material was prepared in the same manner as in Example 1 with the exception of using di(p-methylbenzyl) oxalate in place of 1,2-diphenoxyethane in the preparation of Dispersion C in Example 1.

### Example 4

A heat-sensitive recording material was prepared in the same manner as in Example 1 with the exception of using 3-(N-ethyl-N-isoamylamino)-6-methyl-7-anilinofluoran in place of 3-di(n-butyl)amino-6-methyl-7-anilinofluoran in the preparation of Dispersion A in Example 1.

### Example 5

A heat-sensitive recording material was prepared in the same manner as in Example 1 with the exception of using N-(p-toluenesulfonyl)-m-aminophenol represented by the formula (1) above in place of N-(p-toluenesulfonyl)-p-aminophenol represented by the formula (2) above in the preparation of Dispersion B in Example 1.

### Example 6

A heat-sensitive recording material was prepared in the same manner as in Example 1 with the exception of using 10 parts of Dispersion C and 80 parts of a 20% dispersion of stearic acid amide in place of 30 parts of Dispersion C and 40 parts of the 20% dispersion of stearic acid amide in the preparation of the coating composition for forming a heat-sensitive recording layer in Example 1.

### Example 7

A heat-sensitive recording material was prepared in the same manner as in Example 1 with the exception of using 40 parts of Dispersion C and 20 parts of a 20% dispersion of stearic acid amide in place of 30 parts of Dispersion C and 40 parts of the 20% dispersion of stearic acid amide in the preparation of the coating composition for forming a heat-sensitive recording layer in Example 1.

### Example 8

A heat-sensitive recording material was prepared in the same manner as in Example 1 with the exception of using 42.5 parts of Dispersion C and 15 parts of a 20% dispersion of stearic acid amide in place of 30 parts of Dispersion C and 40 parts of the 20% dispersion of stearic acid amide in the preparation of the coating composition for forming a heat-sensitive recording layer in Example 1.

### Example 9

A heat-sensitive recording material was prepared in the same manner as in Example 1 with the exception of using 1,1,3-tris(2-methyl-4-hydroxy-5-tert-butylphenyl)butane in place of the phenol resin in the preparation of Dispersion D in Example 1.

### Example 10

A heat-sensitive recording material was prepared in the same manner as in Example 1 with the exception of using 1,1,3-tris(2-methyl-4-hydroxy-5-cyclohexylphenyl)butane in place of the phenol resin in the preparation of Dispersion D in Example 1.

### Example 11

A heat-sensitive recording material was prepared in the same manner as in Example 1 with the exception of using a 20% aqueous solution of oxidized starch (trade name: Ace C, manufactured by OJI CORNSTARCH CO., LTD.) in place of 50 parts of the 20% aqueous solution of the vinyl acetate-grafted starch (trade name: PETROCOAT C-8, manufactured by NIPPON STARCH CHEMICAL CO.,LTD.) in the preparation of the coating composition for forming a heat-sensitive recording layer in Example 1.

### Example 12

A heat-sensitive recording material was prepared in the same manner as in Example 1 with the exception of using 2-naphthyl benzyl ether in place of 1,2-diphenoxyethane in the preparation of Dispersion C in Example 1.

### Example 13

A heat-sensitive recording material was prepared in the same manner as in Example 1 with the exception of using 3-di(n-pentyl)amino-6-methyl-7-anilinofluoran in place of 3-di(n-butyl)amino-6-methyl-7-anilinofluoran in the preparation of Dispersion A in Example 1.

### Comparative Example 1

A heat-sensitive recording material was prepared in the same manner as in Example 1 with the exception of using 4,4′-bis (N-(p-toluenesulfonyl)-aminocarbonylamino)-diphenylmethane in place of N-(p-toluenesulfonyl)-p-aminophenol in the preparation of Dispersion A in Example 1.

### Comparative Example 2

A heat-sensitive recording material was prepared in the same manner as in Example 1 with the exception of using benzyl 4-hydroxybenzoate in place of N-(p-toluenesulfonyl)-p-aminophenol in the preparation of Dispersion A in Example 1.

### Comparative Example 3

A heat-sensitive recording material was prepared in the same manner as in Example 1 with the exception of using 50 parts of Dispersion C in place of 30 parts of Dispersion C and 40 parts of the 20% dispersion of stearic acid amide in the preparation of the coating composition for forming a heat-sensitive recording layer in Example 1.

### Comparative Example 4

A heat-sensitive recording material was prepared in the same manner as in Example 1 with the exception of using 100 parts of the 20% dispersion of stearic acid amide in place of 30 parts of Dispersion C and 40 parts of the 20% dispersion of stearic acid amide in the preparation of the coating composition for forming a heat-sensitive recording layer in Example 1.

The thus obtained heat-sensitive recording materials were subjected to evaluation tests described below. The results are shown in Table 1.

[Whiteness]

The whiteness of an unrecorded portion was determined with a Hunter reflectometer. A blue filter was used. The greater the measurement value, the higher the resistance to background fogging.

[Recording Density]

A thermosensitive printing tester (trade name: TH-PMD, manufactured by KABUSHIKI KAISHA OKURA DENKI) was used to record on the heat-sensitive recording materials with 0.3 mJ/dot of applied energy. The density of the recorded portions was measured with a Macbeth densitometer (model RD-914, manufactured by Macbeth) in visual mode.

[Runnability During Recording]

A thermosensitive printing tester (trade name: TH-PMD, manufactured by KABUSHIKI KAISHA OKURA DENKI) was used to record on the heat-sensitive recording materials with 0.25 mJ/dot of applied energy. The runnability during recording was rated using the scale below depending on the degree of sticking of the heat-sensitive recording materials to the thermal head caused during recording.

S: No sticking occurred.

A: Little sticking occurred.

B: Some sticking occurred but the quality of the recorded portion was not reduced.

C: Sticking occurred and the quality of the recorded portion was slightly reduced.

D: Sticking occurred and the quality of the recorded portion was a little reduced.

[Heat Resistance]

The above recorded heat-sensitive recording materials were left to stand at 60° C. for 24 hours. Then, the density of the recorded portions of these heat-sensitive recording materials was measured with a Macbeth densitometer (model RD-914, manufactured by Macbeth) in visual mode. The whiteness of unrecorded portion was measured in the same manner as in the above measurement of whiteness.

[Moisture Resistance]

The above recorded heat-sensitive recording materials were left to stand at a temperature of 40° C. and a relative humidity of 90% for 24 hours. Then the density of recorded portions was determined with a Macbeth densitometer (model RD-914, manufactured by Macbeth) in visual mode. The whiteness of unrecorded portions was measured in the same manner as in the above measurement of whiteness.

TABLE 1

| | | | Heat resistance | | Moisture resistance | | Runnability |
|---|---|---|---|---|---|---|---|
| | | Color | Unrecorded | Recorded | Unrecorded | Recorded | during |
| | Whiteness | density | portion | portion | portion | portion | recording |
| Ex. 1 | 85% | 1.33 | 82% | 1.28 | 84% | 1.30 | S |
| Ex. 2 | 85% | 1.31 | 81% | 1.25 | 83% | 1.30 | S |
| Ex. 3 | 86% | 1.28 | 82% | 1.23 | 84% | 1.25 | S |
| Ex. 4 | 84% | 1.35 | 81% | 1.30 | 82% | 1.31 | S |
| Ex. 5 | 84% | 1.33 | 80% | 1.29 | 84% | 1.30 | S |
| Ex. 6 | 85% | 1.26 | 82% | 1.20 | 84% | 1.25 | B |
| Ex. 7 | 85% | 1.35 | 82% | 1.30 | 84% | 1.31 | A |
| Ex. 8 | 85% | 1.22 | 82% | 1.17 | 84% | 1.20 | B |
| Ex. 9 | 85% | 1.32 | 82% | 1.27 | 84% | 1.27 | S |
| Ex. 10 | 85% | 1.32 | 82% | 1.28 | 84% | 1.30 | S |
| Ex. 11 | 83% | 1.33 | 81% | 1.28 | 82% | 1.30 | S |
| Ex. 12 | 85% | 1.35 | 82% | 1.30 | 84% | 1.31 | S |
| Ex. 13 | 85% | 1.32 | 82% | 1.26 | 84% | 1.28 | S |
| Comp. | 82% | 1.10 | 75% | 1.10 | 60% | 1.10 | S |
| Ex. 1 | | | | | | | |
| Comp. | 85% | 1.30 | 70% | 1.00 | 70% | 1.10 | S |
| Ex. 2 | | | | | | | |
| Comp. | 85% | 1.11 | 82% | 1.05 | 82% | 1.06 | C |
| Ex. 3 | | | | | | | |
| Comp. | 85% | 1.08 | 80% | 1.00 | 79% | 1.01 | D |
| Ex. 4 | | | | | | | |

### INDUSTRIAL APPLICABILITY

The heat-sensitive recording material of the present invention can provide a recorded portion with high stability to heat and humidity and recording sensitivity, and also is excellent in resistance to background fogging and runnability during recording.

1. A heat-sensitive recording material comprising a support and a heat-sensitive recording layer formed on the support, the heat-sensitive recording layer containing a leuco dye, a developer, a sensitizer and a binder, the developer being at least one member selected from the group consisting of N-(p-toluenesulfonyl)-m-aminophenol represented by formula (1) 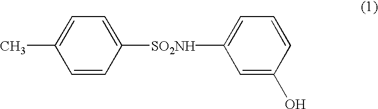
and N-(p-toluenesulfonyl)-p-aminophenol represented by formula (2) 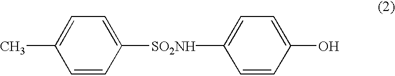
and, the sensitizer being (a) at least one member selected from the group consisting of 1,2-diphenoxyethane, 1,2-di(3-methylphenoxy)ethane, 2-naphthyl benzyl ether and di-p-methylbenzyl oxalate and (b) a higher fatty acid amide.

2. The heat-sensitive recording material according to claim 1, wherein the developer is N-(p-toluene-sulfonyl)-p-aminophenol represented by formula (2).

3. The heat-sensitive recording material according to claim 1, wherein the amount of (a) said at least one member selected from the group consisting of 1,2-diphenoxyethane, 1,2-di(3-methylphenoxy)ethane, 2-naphthyl benzyl ether and di-p-methylbenzyl oxalate is about 40 to 400% by weight, based on (b) said higher fatty acid amide.

4. The heat-sensitive recording material according to claim 1, wherein the amount of (a) said at least one member selected from the group consisting of 1,2-diphenoxyethane, 1,2-di(3-methylphenoxy)ethane, 2-naphthyl benzyl ether and di-p-methylbenzyl oxalate is about 50 to 200% by weight, based on (b) said higher fatty acid amide.

5. The heat-sensitive recording material according to claim 1, wherein the sensitizers are (a) 2-naphthyl benzyl ether and (b) the higher fatty acid amide.

6. The heat-sensitive recording material according to claim 4, wherein the higher fatty acid amide is stearic acid amide.

7. The heat-sensitive recording material according to claim 5, wherein the higher fatty acid amide is stearic acid amide.

8. The heat-sensitive recording material according to claim 1, wherein the heat-sensitive recording layer further contains a print stability-improving agent.

9. The heat-sensitive recording material according to claim 8, wherein the print stability-improving agent is a phenol resin.

10. The heat-sensitive recording material according to claim 1, wherein the leuco dye is at least one member selected from the group consisting of 3-di(n-butyl)amino-6-methyl-7-anilinofluoran, 3-di(n-pentyl)amino-6-methyl-7-anilinofluoran and 3-(N-ethyl-N-isoamylamino)-6-methyl-7-anilinofluoran.

11. The heat-sensitive recording material according to claim 1, wherein the binder in the heat-sensitive recording layer is a graft copolymer of starch and polyvinyl acetate.

12. The heat-sensitive recording material according to claim 11, wherein the graft copolymer has a degree of graft copolymerization of polyvinyl acetate to starch of 0.5 to 10% by weight.

13. The heat-sensitive recording material according to claim 1 which further comprises a protective layer on the heat-sensitive recording layer, the protective layer containing a binder having a film forming ability and, if necessary, a pigment.

14. The heat-sensitive recording material according to claim 1 which further comprises an undercoat layer between the support and the heat-sensitive recording layer, the undercoat layer containing (i) a binder and (ii) at least one member selected from the group consisting of oil absorbing pigments having an oil absorption of at least 70 ml/100 g and hollow organic particles.

15. The heat-sensitive recording material according to claim 14, wherein the oil absorbing pigment is at least one inorganic pigment selected from the group consisting of calcined clay, amorphous silica, precipitated calcium carbonate and talc, the primary particles of said at least one inorganic pigment having an average particle diameter of about 0.01 to 5 μm.

16. The heat-sensitive recording material according to claim 14, wherein the hollow organic particles each comprise a shell made of an acrylic resin, styrenic resin or vinylidene chloride-based resin, the hollow particles having a hollowness of about 50 to 99% and an average particle diameter of about 0.5 to 10 μm.
